(19) United States
(12) Patent Application Publication
(10) Pub. No.: US 2023/0234893 A1
(43) Pub. Date: Jul. 27, 2023

(54) MOLD AND MILDEW RESISTANT WALLBOARD

(71) Applicant: Premier Magnesia, LLC, West Conshohocken, PA (US)

(72) Inventors: Mark A. Shand, Westerville, OH (US); Jerry E. Rademan, Atlanta, GA (US); Christopher McMillan Armstrong, Virginia Beach, VA (US); Robert Hauber, Lutz, FL (US)

(21) Appl. No.: 17/585,661

(22) Filed: Jan. 27, 2022

(51) Int. Cl. C04B 41/45; C04B 41/00; C04B 41/52; C04B 41/63; C04B 41/71

(52) U.S. Cl. CPC C04B 41/4501; C04B 41/009; C04B 41/4596; C04B 41/526; C04B 41/63; C04B 41/71

(57) ABSTRACT

A wallboard product and a method of making a wallboard product are provided. The method may include providing a wallboard core. And exterior surface may be provided to the wallboard core. The exterior surface may include a magnesium compound.

### TECHNICAL FIELD

The present disclosure generally relates to wallboard products, and more particularly relates to mold and mildew resistant wallboard products.

### BACKGROUND

Currently the wallboard market is generally dominated by gypsum-based core materials. Throughout the history of North American gypsum wallboard manufacturing, dating back to the early 1900's, the industry as a whole has experienced persistent problems of wallboard, after being installed on walls, falling victim to mold growth on the front and/or back paper facers. Generally, over the years, the issue of mold growth on gypsum wallboard has not faced significant scrutiny, or liability when mold growth would present itself on finished walls. However, in the early 2000's the gypsum wallboard industry faced a major supply and demand situation that led to importing foreign made wallboard to satisfy the demand. A great majority of the gypsum used to manufacture the imported wallboard is believed to have contained a high level of reclaimed materials as well as naturally occurring minerals that serve as significant food source contributors in the growth and propagation of various forms of mold, including some species of mold that present particular hazards to humans. Consequently, a large number of new homes that were built during the 2000 to 2008 housing boom, were built with these imported wallboards, and subsequently developed rapid and significant mold growth. The problems of mold growth on wallboard was especially prevalent in the southern United States, which experience relatively high temperatures and humidity.

As a result, significant criticism was directed at the wallboard industry as a whole. As a result, the wallboard industry was forced to address the circumstances that lead to mold growth on their products. As early as 2004 the wallboard industry began to prioritize new research and development projects specifically focused on inhibiting the growth of mold on and into their wallboard products. For the last 10 to 15 years, and as a result of those same research and development efforts, two products are predominantly used to impart mold and mildew resistance in gypsum wallboards: Sodium Pyrithione and Zinc Pyrithione. Both of these compounds have proven to be very effective in resolving the problem of mold growth on gypsum wallboards. However, both compounds have a shelf life as far as their individual abilities to inhibit mold growth, and by themselves, neither are believed to be able to withstand environmental atmospheric and or bulk water moisture circumstances and thus all gypsum wallboards manufactured with these compounds must also incorporate the addition of water-resistant additives. Additionally, a new set circumstances have affected the North American gypsum wallboard industry and its markets. In particular, a substantial amount of Sodium Pyrithione and Zinc Pyrithione are manufactured abroad, and thus, maintaining a satisfactory supply of these compounds has become problematic for the US gypsum wallboard industry and its ability to produce mold and mildew resistant wallboards.

### SUMMARY

According to an implementation a method of making wallboard may include providing a wallboard core. The method may also include providing an exterior surface to the wallboard core including a magnesium compound.

One or more of the following features may be included. Providing the exterior surface to the wallboard including the magnesium compound may include providing a coating on an exterior surface of the wallboard core including the magnesium compound. Providing the coating on the exterior surface of the wallboard core may include providing a paper layer including the magnesium compound. The method may also include integrating the paper layer with the wallboard core. Providing the paper layer including the magnesium compound may include mixing the magnesium compound with a paper precursor during manufacture of the paper layer. Mixing the magnesium compound with a paper precursor may include mixing the magnesium compound with a paper pulp. Mixing the magnesium compound with the paper precursor may include mixing the magnesium with a paper pulp feedstock.

A concentration of the magnesium compound may vary across a thickness of the paper layer. The paper layer may include a multi-ply structure. The concentration of the magnesium compound may be higher in at least a first ply than the concentration of the magnesium compound in at least a second ply. Providing a paper layer including the magnesium compound may include applying a coating including the magnesium compound to a surface of the paper layer. Providing a coating on an exterior of the wallboard core may include one or more of spray-coating, roll-coating, and knife-coating an exterior of the wallboard core with a coating material including the magnesium compound.

The magnesium compound may include one, or a mixture of more than one, of magnesium hydroxide, magnesium oxide, magnesium sulfate, magnesium carbonate, magnesium hydro-magnesite, magnesium peroxide, Wollastonite, Boracite, Ankerite, Dolomite (carbonates), Brucite (hydroxide), Lazulite (phosphate), Carnallite (chloride), Periclase (oxide), Enstatite, Iolite, Humite, Cummingtonite, Melilite, Saponite, talc, sapphire, serpentine, jade, Epsomite, Garnierite, Pennine, Hypersynthenite, Monticellite, Kainite, Olivine, Polyhalite, and Keiserite. The magnesium compound may have an alkalinity equal to a pH of about 6 or greater. The magnesium compound may have a pH of between about 8 to about 11. The magnesium compound may have a pH of between about 8.5 to about 10.5.

The magnesium compound may have a particle size of between about 0.01 to about 100 microns. The magnesium compound may have a particle size of between about 10 to about 100 nanometers. The coating may have a thickness of between about 0.015 to about 10 mils.

The exterior surface may further include an additional alkalizing compound including one, or a combination of more than one, of potassium silicate; sodium metasilicate; sodium hydroxide; sodium aluminate; sodium carbonate; hydrated lime; quick lime; dolime; hydrated dolime; potassium oxide; lithium oxide; alumina; iron oxide; nickel oxide; copper oxide; sodium lactate; and calcium gluconate.

According to another implementation, a wallboard product may include a wallboard core. The wallboard product may further include an exterior surface layer integrated with the wallboard core. The exterior surface layer may include a magnesium compound including one, or a mixture of more than one, of: magnesium hydroxide, magnesium oxide, magnesium sulfate, magnesium carbonate, magnesium hydro-magnesite, magnesium peroxide, Wollastonite, Boracite, Ankerite, Dolomite (carbonates), Brucite (hydroxide), Lazulite (phosphate), Carnallite (chloride), Periclase (oxide), Enstatite, Iolite, Humite, Cummingtonite, Melilite, Saponite, talc, sapphire, serpentine, jade, Epsomite, Garnierite, Pennine, Hypersynthenite, Monticellite, Kainite, Olivine, Polyhalite, and Keiserite.

One or more of the following features may be included. The exterior surface layer may include a solidified coating including the magnesium compound. The exterior surface layer may include a paper layer including the magnesium compound.

### BRIEF DESCRIPTION OF THE DRAWINGS

FIG. 1 schematically depicts a wallboard manufacturing arrangement, according to an illustrative example embodiment.

FIG. 2 schematically depicts a paper manufacturing arrangement, according to an illustrative example embodiment.

FIG. 3 diagrammatically depicts a coated paper layer, according to an illustrative example embodiment.

FIG. 4 diagrammatically depicts a wallboard product, according to an illustrative example embodiment.

FIG. 5 diagrammatically depicts another wallboard product, according to an illustrative example embodiment.

### DETAILED DESCRIPTION OF EXAMPLE EMBODIMENTS

The present disclosure generally relates to the use of magnesium-based compounds to provide primary and/or complementary anti-microbial properties for wallboard products. Such primary and/or complementary anti-microbial effects may, for example, prevent, decrease, and/or inhibit the occurrence of mold and/or mildew growth on the wallboard, either during shipment and storage, or after the wallboard has been installed. Consistent with some illustrative example embodiments, the magnesium-based and/or magnesium containing compounds (herein also generally referred to as “magnesium compounds”) may be included in, and/or adjacent to, and exterior surface or face of the wallboard. For example, in one illustrative example embodiment, the magnesium compound may be incorporated into a paper, or other, facing material that may at least partially cover an exterior surface of the wallboard. In another illustrative example embodiment, the magnesium compound may be included in a coating that may be applied to an exterior surface of the wallboard and/or adjacent to the exterior surface of the wallboard (e.g., between a wallboard core material and a facing material covering at least a portion of an exterior surface of the wallboard. Consistent with the present disclosure, the incorporation of the magnesium compounds into, onto, or throughout the matrix of a paper may, in some embodiments, raise the alkalinity of the paper and/or the paper facer's application face/finished working surface of a paper lined/faced wallboard panel to a level of alkalinity that may impart an inhibition to microbial growth, which may, in some embodiments, be a built-in, long-term feature of the paper itself. Various additional and/or alternative implementations consistent with the present disclosure may also be realized.

Consistent with some implementations, a method of making wallboard (e.g., making wallboard products) may generally include providing a wallboard core. The method may also include providing an exterior surface to the wallboard core including a magnesium compound. The wallboard product may include any configuration that may generally be utilized as a wall covering that may provide structural, aesthetic, fire control, or other functions in the context of a house, building, or other structure. Illustrative examples of wallboard may include, but are not limited to, drywall/gypsum panels (e.g., which may include paper, or other suitable facing material, on one or more exterior surfaces of the panel), concrete-based panels (e.g., which may, or may not, include a paper or other suitable facing material on one or more exterior surfaces of the panel), wood-based panels (including, but not limited to, solid wood panels, plywood panels, particle board panels, laminated wood panels, and the like, which may, or may not, include a paper or other suitable facing material on one or more exterior surfaces of the panel), foam-based panels (e.g., which may include a layer of foam, which may include one or more layers of other materials, such as wood, gypsum, and the like, and which may, or may not, include paper or other suitable facing material on one or more exterior surfaces of the panel).

Consistent with the foregoing, the wallboard core may include, but is not limited to, gypsum, wood, concrete, foam, and/or combinations of materials (e.g., which may be arranged in a layered configuration, and/or may be arranged in different portions of the panel). Additionally, the wallboard core may, or may not, include a facing covering at least a portion of one or more exterior surfaces of the panel. Examples of facings may include, but are not limited to, paper, cardstock, cellulose derived materials, textile materials (including woven, mesh, spunbond, or other nonwoven textiles of natural and/or synthetic materials), fiberglass facers and/or backers, wood-based materials (e.g., wood veneer, particle or chip-based wood products), as well as any other suitable materials that may, for example, facilitate painting or finishing the panel, improve the strength or structural integrity of the panel, facilitate installation of the panel, improve fire resistance of the panel, and/or provide and/or improve some other desirable or useful characteristic of the panel.

Consistent with some implementations of the present disclosure, providing the exterior surface to the wallboard including the magnesium compound may include providing a coating on an exterior surface of the wallboard core including the magnesium compound. In one particular illustrative example embodiment, providing the coating on the exterior surface of the wallboard core may include providing a paper layer including the magnesium compound. Such paper layer may include, for example, one or more of a facer layer and a backer layer. Further, consistent with an illustrative example embodiment, the paper layer may be integrated with the wallboard core.

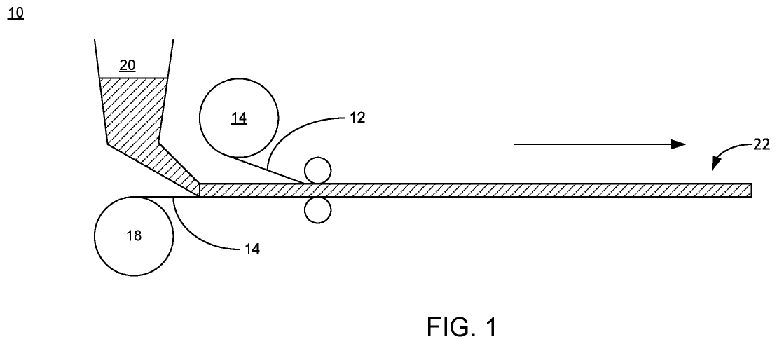

For example, and referring to FIG. 1, an illustrative example of a continuous wallboard production method 10 is schematically depicted. Consistent with the illustrated example embodiment, a wallboard core may be provided with a paper facer and a paper backer. For example, a paper facer layer 12 may be dispensed from a roll 14 (or other suitable source) of facing paper. Similarly, a paper backer layer 16 may be dispensed from a roll 18 (or other suitable source) of backing paper. The facer paper and the backer paper may include the same type of paper and/or may be different types of paper. For example, in some implementations, the facer paper may have a surface that is configured to provide improved paint acceptance, etc., which such characteristics may not be required for the backer paper. Continuing with the illustrated example embodiment, a liquid, slurry, plastic (e.g., shapeable or formable) wallboard core material 20 (e.g., which may include a gypsum-based material, a cement-based material, a foam-based material, a wood fiber-based material, etc.) may be dispensed so as to be disposed between the paper facer layer 12 and the paper backer layer 16. The wallboard including the paper facer layer 12, the core layer 20, and the paper backer layer 16 may be integrated, e.g., as by pressing the paper facer layer 12 and the paper backer layer 16 into the core layer 20 (e.g., via rollers, plattens, etc.), such that the three layers may be generally bonded to one another and/or may otherwise resist separation from one another, thereby providing wallboard product 22. The core material 20 may be subsequently and/or concurrently hardened, cured, or solidifies to provide a rigid panel. In some such embodiments, one or more of the paper facer layer 12, the paper backer layer 16 and the core layer may include an adhesive (either natural or synthetic) to improve bonding between the layers. In some embodiments, an adhesive may be provided as a separate layer and/or a separate component.

While the illustrated example embodiment relates to a wallboard production utilizing a liquid, slurry, or plastic core material, it will be appreciated that other implementations may be utilized. For example, one or more of a paper facer layer and a paper backer layer may be applied to and integrated with a wallboard core that may have a rigid configuration (for example, but not limited to, a plywood core, a rigid foam core, a particleboard core, etc.). Additionally, it will be appreciated that while the illustrated example embodiment depicts a continuous manufacturing process (e.g., which may include subsequent manufacturing steps, such as cutting the panels to size and curing or drying the panels), other implementation may also be utilized.

Consistent with the foregoing illustrative example embodiment, one or both of the paper facer layer and the paper backer layer may include the magnesium compound. Accordingly, the antimicrobial properties of the magnesium compound may be directly incorporated into the wallboard during manufacturing of the wallboard. Further, consistent with some embodiments, the magnesium compound may be included in the paper during manufacturing of the paper itself.

For example, as is generally known, paper facers and backers for wallboard products may generally be formulated using traditional cellulosic fibers of a desired grade, length, and density. Such cellulosic fibers may, for example, include virgin wood pulp, recycled paper products, recycled wood products, etc. Additionally, adhesive formulations, e.g., which may be utilized for forming the paper and/or for assisting in integrating and/or bonding the paper with the wallboard core, may commonly incorporate starch based adhesive compounds. Consistent with some embodiments, the magnesium compounds may be incorporated, in dry or wet formulations, with the cellulose fibers and/or starch that are used for the manufacture of the paper layer.

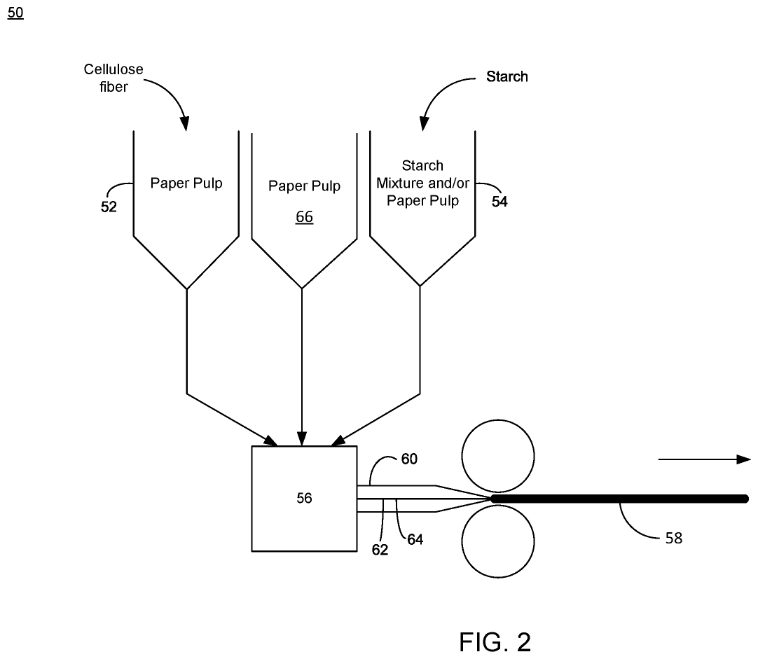

Consistent with the foregoing, providing the paper layer including the magnesium compound may include mixing the magnesium compound with a paper precursor during manufacture of the paper layer. For example, and referring also to FIG. 2, an illustrative example paper manufacturing process 50 is schematically depicted. As generally shown, paper precursors (e.g., which may include, but are not limited to, cellulose fiber and starch) may be added to respective mixing containers 52, 54. The cellulose fiber may be combined with water (or other suitable carrier fluid) and any other suitable components and mixed to form paper pulp. Similarly, starch may be combined with water (or other suitable carrier fluid) and any other suitable component and mixed to form a starch mixture. It will be appreciated that while the starch and cellulose are depicted as residing in separate mixing containers, this is for purpose of explanation, as the cellulose and starch may be added to the same mixing container.

In some embodiments consistent with the present disclosure, mixing the magnesium compound with the paper precursor may include mixing the magnesium with a paper pulp feedstock. Consistent with an illustrative example embodiment, mixing the magnesium compound with a paper precursor may include adding the magnesium compound to the cellulose fibers and/or the starch prior to adding the cellulose fiber and/or the starch to the mixing containers, and/or during adding the cellulose fiber and/or the starch to the mixing containers. In some implementation, mixing the magnesium compound with the paper precursor may occur outside of the paper manufacturing process, e.g., at a source for the cellulose fibers or the starch. Further, as generally noted, the magnesium compound can be added to the paper precursor either wet or dry. For example, the magnesium compound may be provided as an aqueous slurry (and/or using a carrier fluid other than water). This slurry of the magnesium compound may be mixed with the paper precursor. Further, in some implementations, the magnesium compound may be provided as powdered, granular, flake, or other dry product. In such a configuration, the dry product may be mixed with the cellulose fiber, starch, or other paper precursor.

In some implementations, mixing the magnesium compound with a paper precursor may include mixing the magnesium compound with a paper pulp and/or with a starch mixture. For example, and with reference to FIG. 2, the magnesium compound may be added to one or more of the mixing containers 52, 54. As generally discussed, mixing containers 52, 54 may be utilized for forming a slurry or wet paper pulp and/or a slurry or liquid starch. According to such implementations, the magnesium compound may be added, either as a dry component (as discussed above) and/or as a wet component (e.g., a slurry, etc., as also discussed above) to one or more of the mixing containers 52, 54, which may contain paper pulp and/or starch mixture utilized for the manufacture of paper.

In yet a further illustrative example embodiment, providing the paper layer including the magnesium compound may include providing the magnesium compound to a conduit carrying the paper pulp and/or starch mixture to the headbox 56 (and/or more than one headbox) of the paper production line, and/or adding the magnesium compound directly to the headbox 56. In some such implementations, the magnesium compound may be conveniently added to the conduits and/or the headbox as a slurry and/or aqueous mixture (or a mixture including another suitable liquid phase). Depending upon the paper pulp slurry composition, in some implementations it may be useful to include a dispersant in the slurry of magnesium compound to increase the homogeneity and/or dispersion of the magnesium compound within the paper pulp and within the resulting paper product (e.g., paper 58).

Further, in some implementations, the magnesium compound may be encapsulated into polymeric-based binders, e.g., which may be utilized for coating one or surfaces of the paper, and/or one or more paper component. Such polymeric-based binders may be incorporated as part of the paper manufacturing process, and may be dispensed through the headbox and/or may be applied to the paper after manufacture of the paper. Illustrative example embodiments of suitable polymeric-based binders may include, but are not limited to, mono-, co-polymer, or tertiary polymers of acrylic, vinyl acrylates or acetates, or any other suitable thermoplastic or thermoset compounds.

Consistent with the foregoing, a paper product 58 may be produced including the magnesium compound. In some illustrative example embodiments, the magnesium compounds may actually provide improved strength in the final cellulose paper fibers, e.g., in the final dried paper matrix. It will be appreciated that while a variety of approaches have been described for producing paper including magnesium compounds, additional and/or alternative approaches may also be utilized. Further, combination of the various approaches may be implemented, e.g., whereby the magnesium compound may be added at more than one stage and/or through more than one approach.

Consistent with some implementations, the concentration of the magnesium compound may be generally consistent throughout the paper. Further, consistent with some implementations, the concentration of the magnesium compound may vary across the thickness of the paper layer. For example, is has been standard practice in the gypsum wallboard industry to use paper facers and/or paper backers that may be manufactured as multi-ply paper layers. For example, various building codes, regulations, industry standards, and the like may specify the required physical strength minimum performance characteristics for gypsum wallboard. In order to meet the required performance characteristics, gypsum wallboard facers and backer may frequently include multi-ply paper layers, which may have, for example, between three to seven plies, although paper layers with other ply counts may also be implemented.

Consistent with some implementations of the present disclosure, the paper may include a multi-ply structure. Further, in some such implementations, the concentration of the magnesium compound may be higher in at least a first play than the concentration of the magnesium compound in at least a second ply. For example, and with continued reference to FIG. 2, in the illustrated example embodiment, paper 58 is shown including a three-ply structure, e.g., which may be formed from plies 60, 62, 64 that are consolidated (e.g., via rollers, or the like) into paper 58. Consistent with various embodiments, the concentration in each of the plies may be the same, and/or one or more plies may have a different concentration of magnesium compound relative to one or more of the other plies. Consistent with such an implementation, the mold, mildew, and/or antimicrobial effect provided by the magnesium compound may be striated in strength across the thickness of the paper layer 58. This striated strength may be based upon, for example, one or more of the quantity of magnesium compound, the concentration of magnesium compound, and/or composition of the magnesium compound included in each of the plies of the paper layer 58. For example, as shown in FIG. 2, in some implementations the paper pulp utilized for each ply of the paper 58 may be provided from a different paper pulp container (e.g., containers 52, 54, 66). As such, it may be possible to provide a different quantity, concentration, and/or type of magnesium compound associated with each paper pulp container, which may result in a different quantity, concentration, and/or type of magnesium compound associated with each respective ply of the paper 58.

In one implementation, the antimicrobial effect of the magnesium compound may be, at least in part, correlated with the alkalinity provided by the magnesium compound. In an illustrative example embodiment, the antimicrobial effect (e.g., including mildew and/or mold resistance) may be striated throughout the thickness of the paper to provide the greatest antimicrobial effect adjacent a portion of the paper that may be the outermost portion of the final wallboard panel, and to provide the least antimicrobial effect adjacent a portion of the paper that may be the innermost/closest to the wallboard core. Since mold growth may be expected to be most likely to start from the exterior of the wallboard panel, constructing the paper layer to provide the highest concentration of the magnesium compound and/or the greatest antimicrobial effect provided by the magnesium compound may provide the highest protection, while conserving costs associated with the quantity and type of magnesium compound utilized. In an implementation, the antimicrobial effect may be based upon, at least in part, an alkalinity distribution and/or striation across the thickness of the paper provided by the magnesium compound.

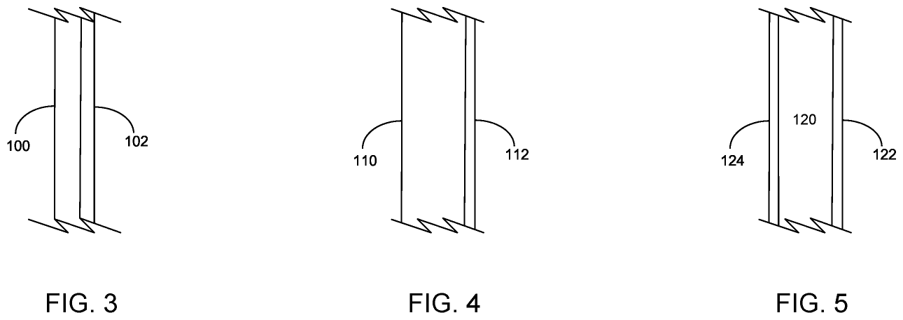

According to some implementations consistent with the present disclosure, providing a paper layer including the magnesium compound may include applying a coating including the magnesium compound to a surface of the paper layer. For example, and referring to FIG. 3, a paper layer 100 may be provided. The paper layer may include a single-ply and/or a multi-ply paper layer. A coating of the magnesium compound 102 may be applied to the paper, to thereby provide the paper with an antimicrobial effect (e.g., including mold and/or mildew resistance). While the paper is shown only including a coating of the magnesium compound on one surface thereof, it will be appreciated that a coating of magnesium compound may be applied to both faces of the paper. According to an implementation, the coating of magnesium compound may be applied to the paper after manufacture of the paper, but before the paper is integrated with the wallboard core. In some implementations, the coating of the magnesium compound may be applied to the paper after the paper layer has been integrated with the wallboard core.

Any various coating techniques may be utilized for applying the coating of magnesium compound to the paper. Illustrative example of coating techniques may include, but are not limited to, spray coating, roll coating, blading or screeding, and the like. Consistent with some implementations, the magnesium compound may be applied as a wet coating, e.g., with the magnesium compound being provided as a slurry or suspension in water, or other suitable liquid carrier, which may facilitate coating the paper and adhering the magnesium compound to the fibers of the paper. As will be appreciated the wet magnesium compound composition may be adjusted to provide a suitable viscosity based upon, at least in part, the coating technique utilized and a desired thickness of the coating. Consistent with various embodiments, the coating may be provided having a thickness of between about 0.015 to about 10 mils. A thicker coating of the magnesium compound may generally provide a more substantial overall mold and/or mildew inhibiting properties.

Consistent with various embodiments, the paper layer may include varying amounts of magnesium compound, whether the magnesium compounds are added during the paper manufacturing process and/or applied as a coating to the paper. According to some embodiments, the magnesium compounds may be included at between about 0.5 to about 40% by weight of the dry weight of the paper. In some particular implementations, the magnesium compound may be included at between about 1 to about 10% by weight of the dry weight of the paper. Various other concentrations may also be utilized. Further, the concentration may vary based upon, at least in part, the type of the magnesium compound utilized.

Consistent with some example embodiments, and as generally discussed above, providing a coating on an exterior of the wallboard core may include one or more of spray-coating, roll-coating, and knife-coating an exterior of the wallboard core with a coating material including the magnesium compound. For example, in a similar manner to applying a coating to a paper layer (that may be integrated with the wallboard core and/or may be intended to be integrated with a wallboard core), the magnesium compound may be directly coated onto the wallboard core. With reference to FIG. 4, in an illustrative example embodiment, wallboard core 110 may include a coating of magnesium compound 112 applied directly to a surface of the wallboard core. Further, similar with magnesium compound coating applied to a paper layer, a magnesium compound coating applied to a wallboard core may have a thickness of between about 0.015 to about 10 mils.

As generally discussed above, the magnesium compound may provide an antimicrobial effect (e.g., including providing at least some degree of mold and/or mildew resistance. According to various embodiments, the magnesium compound may include, but is not limited to, one, or a mixture of more than one, of magnesium hydroxide, magnesium oxide, magnesium sulfate, magnesium carbonate, magnesium hydro-magnesite, magnesium peroxide, Wollastonite, Boracite, Ankerite, Dolomite (carbonates), Brucite (hydroxide), Lazulite (phosphate), Carnallite (chloride), Periclase (oxide), Enstatite, Iolite, Humite, Cummingtonite, Melilite, Saponite, talc, sapphire, serpentine, jade, Epsomite, Garnierite, Pennine, Hypersynthenite, Monticellite, Kainite, Olivine, Polyhalite, and Kieserite. Consistent with a particular illustrative example embodiment in which the magnesium compound includes magnesium oxide, such magnesium oxide may be derived from either natural and/or synthetic processes. Further, various classes of magnesium oxide may be utilized, including, but not limited to, dead burned from Magnesite calcining, hard bunt, light burned from a flash calcining process, as well as combinations and/or mixtures of classes of magnesium oxide. In some particular illustrative example embodiments, the magnesium oxide may include relatively highly reactive grades, such as flash calcined Magnesite grades, synthetic grades and/or natural calcined in a Herreshoff multi-hearth furnace. In some implementations, such magnesium oxides may exhibit a caustic magnesia activity neutralization time of between about 9 to about 30 seconds using 1.0N acetic acid. In some implementations, magnesium oxide grades with even higher reactivity times may be utilized as either a primary and/or secondary magnesium oxide grade to lighter burned magnesium oxide grades. Consistent with some embodiments, the magnesium compounds may be produced from either ground and crushed solid minerals, or from mineral particle aqueous dispersions, with may, for example, including mineral contents ranging from about 10% to about 85% in water.

In some illustrative example embodiments, some magnesium compounds, such as magnesium oxide, may exhibit the ability to absorb carbon dioxide and/or formaldehyde from the atmosphere. In some particular implementations, depending upon how magnesium oxide is produce, magnesium oxide may be capable of providing either a carbon-neutral, or in some cases, a carbon-negative impact on the atmosphere. Consistent with some such implementations, the use of the magnesium compounds may allow for Carbon Credits for the builder, designer, or owner of a building or dwelling constructed using wallboard panels consistent with the present disclose. Further, formaldehyde has been recognized as an environmental nuisance for building materials (including, but not limited to, gypsum-based wallboard). This may arise, at least in part, because formaldehyde is used as a co-polymer in various building products, and can be released overtime through oxidative decomposition and other physical and/or chemical degradation processes. As such, the ability of some magnesium compound to absorb formaldehyde from the atmosphere may, at least in part, alleviate the nuisance impact of formaldehyde in building projects utilizing wallboard panels consistent with some embodiments of the present disclosure. Additionally, in some illustrative example embodiments, some magnesium compounds, such as magnesium hydroxide, may provide at least some level of increased fire resistance to the entire wallboard panel (such as gypsum wallboard panels, and/or other wallboard panels). As such, magnesium compounds, such as magnesium hydroxide (and/or other magnesium compounds) may also provide secondary fire resistance for the wallboard panel, in addition to the primary mold and/or mildew resistance (e.g., primary antimicrobial properties).

As generally discussed above, in some implementations, at least a portion or the antimicrobial effect, and/or mold and mildew resistance provided by the magnesium compounds may be based upon the alkalinity of the magnesium compounds. Consistent with some illustrative example embodiments, the magnesium compound may have an alkalinity equal to a pH of about 6 or greater. Further, in some particular embodiments, the magnesium compound may have a pH of between about 8 to about 11. In still further illustrative example embodiments, the magnesium compound may have a pH of between about 8.5 to about 10.5.

Consistent with some embodiments, the exterior surface of the wallboard core may further include an additional alkalizing compound. The additional alkalizing compound may include one, or a combination of more than one, of, but not limited to, potassium silicate, sodium metasilicate, sodium hydroxide; potassium hydroxide, sodium aluminate, sodium carbonate, hydrated lime, quick lime, dolime, hydrated dolime, potassium oxide, lithium oxide, alumina, iron oxide, nickel oxide, copper oxide, sodium lactate, and calcium gluconate. The additional alkalizing compounds may be used in combination with the magnesium compounds to achieve a desired pH for a given application. Further, known antimicrobial compounds may also be used in combination with the magnesium compounds and/or the additional alkalizing compounds to further enhance the desired antimicrobial effects. One or more of the additional alkalizing compounds and/or known antimicrobial compounds may be combined with the magnesium compounds and included in the paper layer and/or applied to the wallboard core. Further, in some implementations, one or more of the additional alkalizing compounds and/or known antimicrobial compounds may be separately included in the paper layer and/or applied to an exterior surface of the wallboard core, e.g., in any of the manners as variously described with respect to the magnesium compound.

Consistent with some embodiments, the particle size of one or more of the magnesium compounds and the additional alkalizing compound may be selected to provide a desired alkalinity distribution. For example, alkalinity distribution may depend, at least in part, on the mass of the magnesium compound per unit surface area, or per unit volume. Further the mass of the particles may be related to the size and density of the particles. Typically, the smaller the particle size, the greater the surface area. The greater the surface area, the faster the reactivity of the magnesium compound, which can accelerate the desired reactions for inhibiting mold and/or mildew growth. Larger particle size may generally have a greater reserve alkalinity (e.g., may provide a desired level of alkalinity for a longer duration) than a smaller particle, due to the larger particle having a greater mass. As noted, smaller particles may have better coverage than larger particles (e.g., may react faster) but may have a smaller reserve alkalinity (e.g., and may therefore provide mold and/or mildew resistance for a shorter period of time than larger particles). The magnesium compound(s) may have a particle size of between about 0.01 to about 100 microns. The magnesium compound may have a particle size of between about 10 to about 100 nanometers. As previously discussed, concentration, quantity, and/or type of magnesium compound may be striated across the thickness of a paper layer. Similarly, particle size of magnesium compound may also be striated across the thickness of the paper layer, e.g., with one ply including magnesium compound having a smaller particle size than the particle size of magnesium compound in at least another ply of a multi-ply paper layer.

According to an illustrative example embodiment, a wallboard product may include a wallboard core, and may include an exterior surface layer integrated with the wallboard core. That is, the exterior surface layer may be joined, adhered, bonded, fused, etc., with the wallboard core to resist separation of the exterior layer from the wallboard core, and/or the exterior surface layer may be an integral feature of the wallboard core. Further, the exterior surface layer may include the same material and/or a different material than the wallboard core. The exterior surface layer may include a magnesium compound including one, or a mixture of more than one, of magnesium hydroxide, magnesium oxide, magnesium sulfate, magnesium carbonate, magnesium hydro-magnesite, magnesium peroxide, Wollastonite, Boracite, Ankerite, Dolomite (carbonates), Brucite (hydroxide), Lazulite (phosphate), Carnallite (chloride), Periclase (oxide), Enstatite, Iolite, Humite, Cummingtonite, Melilite, Saponite, talc, sapphire, serpentine, jade, Epsomite, Garnierite, Pennine, Hypersynthenite, Monticellite, Kainite, Olivine, Polyhalite, and Keiserite. Consistent with one illustrative example embodiment, the exterior surface layer may include a solidified coating including the magnesium compound. For example, and referring to FIG. 4, a wallboard core 110 (as generally described herein) may include a solidified coating of magnesium compound 112, e.g., as may be applied by spray coating, roller coating, screeding, etc., that may exist in a solid state in the finished wallboard product, and may have been applied from a liquid or slurry state. Further, in some illustrative example embodiments, the exterior surface layer may include a paper layer including the magnesium compound. For example, and referring to FIG. 5, a wallboard core 120 may include a paper facer layer 122, and a paper backer layer 124. One or more of the paper facer layer and the paper backer lay may include a magnesium compound (e.g., as generally described above.

Herein, the present disclosure has generally related to wallboard products. However, it will be appreciated that the concepts herein are susceptible to use in a variety of applications. For example, implementations of the present disclosure may be used in connection with any and all substrates for which paper, composed of a single or multi-ply arrangement, may be use as a face or back line, carrying and/or holding sheet, in which the incorporation of antimicrobial properties may be useful. As such, the present disclosure should not be limited to the particular illustrative embodiments described herein.

While various features, embodiments, and implementations have been described, it will be understood that such description is intended for the purpose of illustration and explanation, and should not be construed as limiting on the scope of the present disclosure. Additionally, while several embodiments have been described including various features, it will be understood that the described features are susceptible to combination with features described in connection with out embodiments. As such, the features, advantages, and implementations described across the various embodiments may be combined with one another to provide additional embodiments and implementations. As such, the present disclosure should be understood to encompass any combination of features, advantages, and implementations described herein.

What is claimed is:

1. A method of making wallboard comprising:
providing a wallboard core; and
providing an exterior surface to the wallboard core comprising a magnesium compound.

2. The method according to claim 1, wherein providing the exterior surface to the wallboard comprising the magnesium compound includes:
providing a coating on an exterior surface of the wallboard core comprising the magnesium compound.

3. The method according to claim 2, wherein providing the coating on the exterior surface of the wallboard core includes:
providing a paper layer including the magnesium compound; and
integrating the paper layer with the wallboard core.

4. The method according to claim 3, wherein providing the paper layer including the magnesium compound includes:
mixing the magnesium compound with a paper precursor during manufacture of the paper layer.

5. The method according to claim 4, wherein mixing the magnesium compound with a paper precursor includes one or more of:
mixing the magnesium compound with a paper pulp; and
mixing the magnesium with a paper pulp feedstock.

6. The method according to claim 3, wherein a concentration of the magnesium compound varies across a thickness of the paper layer.

7. The method according to claim 6, wherein the paper layer includes a multi-ply structure, and wherein the concentration of the magnesium compound is higher in at least a first ply than the concentration of the magnesium compound in at least a second ply.

8. The method according to claim 3, wherein providing a paper layer including the magnesium compound includes applying a coating including the magnesium compound to a surface of the paper layer.

9. The method according to claim 2, wherein providing a coating on an exterior of the wallboard core includes one or more of spray-coating, roll-coating, and knife-coating an exterior of the wallboard core with a coating material including the magnesium compound.

10. The method according to claim 1, wherein the magnesium compound includes one, or a mixture of more than one, of: magnesium hydroxide, magnesium oxide, magnesium sulfate, magnesium carbonate, magnesium hydro-magnesite, magnesium peroxide, Wollastonite, Boracite, Ankerite, Dolomite (carbonates), Brucite (hydroxide), Lazulite (phosphate), Carnallite (chloride), Periclase (oxide), Enstatite, Iolite, Humite, Cummingtonite, Melilite, Saponite, talc, sapphire, serpentine, jade, Epsomite, Garnierite, Pennine, Hypersynthenite, Monticellite, Kainite, Olivine, Polyhalite, and Keiserite.

11. The method according to claim 1, wherein the magnesium compound has an alkalinity equal to a pH of about 6 or greater.

12. The method according to claim 11 wherein the magnesium compound has a pH of between about 8 to about 11.

13. The method according to claim 11, wherein the magnesium compound has a pH of between about 8.5 to about 10.5.

14. The method according to claim 1, wherein the magnesium compound has a particle size of between about 0.01 to about 100 microns.

15. The method according to claim 14, wherein the magnesium compound has a particle size of between about 10 to about 100 nanometers.

16. The method according to claim 2, wherein the coating has a thickness of between about 0.015 to about 10 mils.

17. The method according to claim 1, wherein the exterior surface further comprises an additional alkalizing compound including one, or a combination of more than one, of potassium silicate; sodium metasilicate; sodium hydroxide; sodium aluminate; sodium carbonate; hydrated lime; quick lime; dolime; hydrated dolime; potassium oxide; potassium hydroxide, lithium oxide;
alumina; iron oxide; nickel oxide; copper oxide; sodium lactate; and calcium gluconate.

18. A wallboard product comprising:
a wallboard core; and
an exterior surface layer integrated with the wallboard core, the exterior surface layer comprising a magnesium compound including one, or a mixture of more than one, of: magnesium hydroxide, magnesium oxide, magnesium sulfate, magnesium carbonate, magnesium hydro-magnesite, magnesium peroxide, Wollastonite, Boracite, Ankerite, Dolomite (carbonates), Brucite (hydroxide), Lazulite (phosphate), Carnallite (chloride), Periclase (oxide), Enstatite, Iolite, Humite, Cummingtonite, Melilite, Saponite, talc, sapphire, serpentine, jade, Epsomite, Garnierite, Pennine, Hypersynthenite, Monticellite, Kainite, Olivine, Polyhalite, and Keiserite.

19. The wallboard product according to claim 18, wherein the exterior surface layer includes a solidified coating including the magnesium compound.

20. The wallboard product according to claim 18, wherein the exterior surface layer includes a paper layer including the magnesium compound.
